(19) United States
(12) Patent Application Publication
(10) Pub. No.: US 2008/0259441 A1
(43) Pub. Date: Oct. 23, 2008

(54) Imaging System

(75) Inventors: David Shafer, Fairfield, CT (US); Aurelia Dodoc, Oberkochen (DE); Karl-Heinz Schuster, Koenigsbronn (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 12/146,357

(22) Filed: Jun. 25, 2008

Related U.S. Application Data
(63) Continuation of application No. 11/347,315, filed on Feb. 6, 2006.
(60) Provisional application No. 60/649,555, filed on Feb. 4, 2005.

(51) Int. Cl. G02B 17/08

(52) U.S. Cl. 359/364

(57) ABSTRACT

An imaging system for imaging an object field arranged in an object surface of the imaging system onto an image field arranged in an image surface of the optical system while creating at least one intermediate image including: a first imaging subsystem for creating the intermediate image from radiation coming from the object surface, the first imaging subsystem having a first optical axis; and a second imaging subsystem different in construction from the first imaging subsystem for imaging the intermediate image onto the image surface, the second imaging subsystem having a second optical axis; wherein the first optical axis is offset with respect to the second optical axis by an axis offset at the intermediate image and wherein the intermediate image has a correction status adapted to the axis-offset such that the correction status of the image field is essentially free from aberrations caused by the axis-offset.

This application is a continuation of U.S. patent application Ser. No. 11/347,315, filed Feb. 6, 2006, which claims the benefit of U.S. Provisional Application No. 60/649,555, filed Feb. 4, 2005. The full disclosures of application Ser. Nos. 11/347,315 and 60/649,555 are hereby incorporated into the present application by reference.

### BACKGROUND OF THE INVENTION

1. Field of the Invention

The invention relates to an imaging system for imaging an object field arranged in an object surface of the imaging system onto an image field arranged in an image surface of the imaging system while creating at least one intermediate image. In a preferred field of application the imaging system is designed as a catadioptric projection objective for a microlithographic projection exposure system designed for projection using radiation in the ultraviolet spectrum.

2. Description of Related Art

Catadioptric projection objectives are, for example, employed in projection exposure systems, in particular wafer scanners or wafer steppers, used for fabricating semiconductor devices and other types of microdevices and serve to project patterns on photomasks or reticles, hereinafter referred to generically as “masks” or “reticles,” onto an object having a photosensitive coating with ultrahigh resolution on a reduced scale.

In order create even finer structures, it is sought to both increase the image-end numerical aperture (NA) of the projection objective and employ shorter wavelengths, preferably ultraviolet light with wavelengths less than about 260 nm. However, there are very few materials, in particular, synthetic quartz glass and crystalline fluorides, that are sufficiently transparent in that wavelength region available for fabricating the optical elements required. Since the Abbe numbers of those materials that are available lie rather close to one another, it is difficult to provide purely refractive systems that are sufficiently well color-corrected (corrected for chromatic aberrations).

The high prices of the materials involved and limited availability of crystalline calcium fluoride in sizes large enough for fabricating large lenses represent problems, particularly in the field of microlithography at 157 nm for very large numerical apertures, for example NA=0.80 and larger. Measures allowing to reduce the number and sizes of lenses employed and simultaneously contribute to maintaining, or even improving, imaging fidelity are thus desired.

In optical lithography, high resolution and good correction status have to be obtained for a relatively large, virtually planar image field. It has been pointed out that the most difficult requirement that one can ask of any optical design is that it has a flat image, especially if it is an all-refractive design. Providing a flat image requires opposing lens powers and that leads to stronger lenses, more system length, larger system glass mass, and larger higher-order image aberrations that result from the stronger lens curvatures.

Conventional means for flattening the image field, i.e. for correcting the Petzval sum in projection objectives for microlithography are discussed in the article “New lenses for microlithography” by E. Glatzel, SPIE Vol. 237 (1980), pp. 310-320.

In view of the aforementioned problems, catadioptric systems that combine refracting and reflecting elements, i.e., in particular, lenses and concave mirrors, are primarily employed for configuring high-resolution projection objectives of the aforementioned type.

Concave mirrors in optical imaging systems have been used for some time to help solve problems of color correction and image flattening. A concave mirror has positive power, like a positive lens, but the opposite sign of Petzval curvature. Also, concave mirrors do not produce color problems.

Unfortunately, a concave mirror is difficult to integrate into an optical design, since it sends the radiation right back in the direction it came from. An off-axis field must be used if an image free of obscuration and beam vignetting is desired. However, when using an off-axis field the diameter for which an optical system must be sufficiently corrected becomes relatively larger when compared to centered systems. This increases the demands for correcting imaging errors and typically optical elements with larger diameters are needed. Further, with off-axis fields it is more difficult to obtain a large geometrical light guidance value (etendue), i.e. large values for the product of the image field size and image side numerical aperture. Intelligent designs integrating concave mirrors without causing mechanical problems or problems due to beam vignetting or obscuration are desirable.

Concatenated imaging systems have frequently been used to account for conflicting requirements on an optical system with regard to correction of image aberrations. The term “concatenated system” as used here refers to an imaging system that includes a first imaging subsystem for creating an intermediate image from radiation coming from the object surface of the imaging system and a second imaging subsystem for imaging the intermediate image onto the image surface. In concatenated systems two or more imaging subsystems are linked together at intermediate images, where an intermediate image is the image formed by a subsystem upstream of the intermediate image and serves as the object of a subsystem downstream of the intermediate image.

U.S. Pat. No. 5,052,763 (Singh et al.) discloses an optical system including an input subsystem and an output subsystem linked by an intermediate image between the subsystems. The input optical subsystem and the output optical subsystem share a common optical axis folded at planar reflecting surfaces. The input subsystem is a catadioptric system providing overcorrection of Petzval sum such that a curved intermediate image is formed. The Petzval sum of the entire system is corrected by compensation of the field curvature of the input subsystem with that of the output subsystem resulting in a flat image field. Also, the input and output subsystems are essentially separately corrected for odd aberrations, such as coma and distortion, whereas even aberrations, such as spherical aberration, astigmatism and field curvature are substantially corrected by compensation between the subsystems.

U.S. Pat. No. 4,812,028 (Matsumoto) describes a reflection type reduction projection optical system for optical lithography comprising first and second optical subsystems which are combined to set a Petzval sum of the entire system to zero, i.e. to obtain a flat image field. The optical subsystems share a common optical axis which may be folded at planer mirror surfaces. The system includes at least one aplanatic refracting surface. The Petzval sum of all the aplanatic refracting surfaces together and of all the remaining reflective and refractive surfaces is corrected independently of each other.

U.S. Pat. No. 4,798,450 (Suzuki) discloses an optical imaging system including a first off-axis optical system for receiving light from an off-axis object field and emitting that light and a second off-axis optical system for receiving light from the first optical system to form an image in an off-axis image field. The first optical system creates an intermediate image serving as the object of the second optical system. The first and second off-axis optical systems define two separate optical axes parallel offset to each other at the intermediate image. The first and second off-axis optical systems each are Offner-type catadioptric systems having identical construction. The Offner-type systems are arranged in a point-symmetric arrangement with respect to the intermediate image. Each subsystem produces astigmatism, where the astigmatism of the second optical system minimizes the astigmatism produced by the first optical subsystem such that the image formed by the second optical subsystem is substantially free of astigmatism within a predetermined height from the optical axis of the second subsystem.

Japanese patent application with publication No. JP 2003-185923 shows another example of two off-axis optical systems having parallel offset optical axes and being linked at an intermediate image. 90° folding mirrors at the entrance of the first system and at the exit of the second system serve to orient the surface of the intermediate image on a plane crossing the object plane and image plane.

U.S. Pat. No. 6,590,718 B2 (Fürter et al.) discloses projection exposure systems having a reflective reticle, wherein in the projection objective a first beam splitter is provided for superimposing an illuminating beam path between a light source of the illuminating system and the reflective reticle and an imaging beam path between the reflective reticle and the image plane of the projection objective. The beam splitter is arranged in a first, refractive subsystem forming a first intermediate image of the pattern provided by the reflective reticle. In one embodiment, the intermediate image is imaged onto the image plane by a catadioptric subsystem which formes a second intermediate image and a refractive subsystem imaging the second intermediate image onto the image plane. The first intermediate image is centered with respect to the optical axis of the first, refractive subsystem, but decentered with respect to the optical axis of the second, catadioptric subsystem which includes a concave mirror. A parallel offset of the first and second optical axis exists at the first intermediate image. No information is given on the correction status of the intermediate images.

### SUMMARY OF THE INVENTION

Objects of the invention include providing an imaging system having high image side numerical aperture and a flat image field and which can be built with relatively small amounts of transparent optical material. It is another object of the invention to provide an optical imaging system which can be used as or allows to provide a catadioptric projection objective for microlithography suitable for use in the vacuum ultraviolet (VUV) range having potential for very high image side numerical aperture which may extend to values allowing immersion lithography at numerical apertures NA>1.

According to one formulation, the invention provides an imaging system for imaging an object field arranged in an object surface of the imaging system onto an image field arranged in an image surface of the optical system while creating at least one intermediate image comprising:

a first imaging subsystem for creating the intermediate image from radiation coming from the object surface, the first imaging subsystem having a first optical axis; and
a second imaging subsystem different in construction from the first imaging subsystem for imaging the intermediate image onto the image surface, the second imaging subsystem having a second optical axis;
wherein the first optical axis is offset with respect to the second optical axis by an axis offset at the intermediate image and wherein the intermediate image has a correction status adapted to the axis offset such that the correction status of the image field is essentially free from aberrations caused by the axis offset.

In the following description the term “optical axis” shall refer to a straight line or a sequence of a straight-line segments passing through the centers of curvature of the optical elements of an optical imaging system. The optical axis may be folded by folding mirrors (deflecting mirrors) or other reflective surfaces. Generally, an optical axis of a subsystem may be folded at a planar mirror surface or may be unfolded (straight).

The term “offset” is used to characterize a situation where the first and second optical axis are non-coaxial at the intermediate image. The offset may be a parallel offset such that the first and second optical axes are parallel and separated by a lateral offset distance. An angular offset where the first and second optical axis are tilted with respect to each other and include a finite offset angle is also possible. The first and second optical axis may be relatively tilted such that the axes intersect at an axis intersection point. It is also possible that the first and second optical axes are relatively tilted but do not intersect. With other words: a combination of parallel and angular offset is possible.

It has been found that a defined offset between the first and second optical axis at the intermediate image can be used to allow constructing the subsystems linked at the intermediate image in an optimized manner. However, a transfer of optical information between the subsystems linked at the intermediate image without significant loss of information and/or without introducing imaging errors requires careful considerations regarding the correction status and arrangement of the intermediate image. Some or all of following conditions should be observed as good as possible when two imaging subsystems are coupled or linked at an intermediate image.

First condition: The image location of the subsystem upstream of the intermediate image should coincide with the object location of the subsystem downstream of the intermediate image as close as possible. If the first condition is violated, then a paraxial arrangement of the subsystems cannot be obtained leading to consequences such as modified magnification or image plane position.

Second condition: the exit pupil of the subsystem upstream of the intermediate image should coincide with the entrance pupil of the subsystem downstream of the intermediate image as close as possible in terms of size, shape and position. If the second condition is violated, then the intermediate image cannot be imaged into the image plane without vignetting.

Third condition: if the intermediate image is not completely corrected for image aberrations then the subsystem downstream of the intermediate image should be constructed such that the residual aberrations of the intermediate image can be corrected such that a final image having a desired degree of image aberrations is obtained. The level up to which deviations from a completely corrected status are tolerable depends on the actual application. Particularly, in the field of microlithography a flat image field across the entire area of the image field must be approximated as good as possible. Generally, a deviation in axial direction from an ideally flat intermediate image should be smaller than the depth of focus (DOF) of the imaging system.

The first, second and third condition mentioned above apply for all concatenated systems independent of whether the first and second optical axis coincide at the intermediate image or whether they are offset with respect to each other. The term “concatenated” system refers to optical systems which have imaging subsystems linked at intermediate images.

The first to third conditions should also be met if a field is positioned outside the optical axis (off-axis field).

In the terminology used throughout this application a “field” of an optical system (object field, intermediate image, image field) is described as “off-axis” to an optical axis if this optical axis is not used. With other words, the optical axis under consideration does not intersect the field. Usually, there is a finite lateral distance between the optical axis and the off-axis field. The smallest lateral distance between an optical axis and a field is also denoted “inner field height”.

Generally, a field may be decentered with respect to an optical axis, but one field point of the field may be on the optical axis. A field position of this type will be denoted as an “axial field” in contradistinction to an “off-axis field” mentioned above. Axial fields include perfectly centered fields as well as fields which are decentered with respect to an optical axis. Fields which are “essentially centered” on an optical axis will be denoted as “on-axis” field in the following.

If an intermediate image represents an axial field for the following imaging system such that one field point lies on the optical axis of the following imaging system then the following conditions should be observed to obtain a high quality image:

Fourth condition: the intermediate image or at least one intermediate image point positioned outside the optical axis should be essentially free of asymmetric aberrations and astigmatism.

Fifth condition: the correction status of the intermediate image with respect to image aberrations should be essentially constant across the intermediate image or should be at least symmetric with respect to an axis going through one intermediate image point positioned outside the optical axis.

If the intermediate image can be provided such that these conditions are closely met then the off-axis intermediate image point for which the conditions are fulfilled can be used as an intersection point at which the second optical axis intersects the intermediate image surface. In this case the axis of aberration state symmetry of the intermediate image and the second optical axis coincide.

In some embodiments the intermediate image is essentially centered around the second optical axis and defines an intermediate image surface, the first optical axis intersects the intermediate image surface at an intersection point eccentrically to the second optical axis and the intermediate image is corrected for image aberrations such that image aberrations are essentially symmetrical with respect to the second optical axis. This is possible, for example, if the aberrations at the intermediate image have essentially no field variations. In this case the correction status of the intermediate image can be essentially constant across the intermediate image. It is also possible, that the correction status is not constant across the intermediate image, but axially symmetric with respect to the second optical axis.

A number of advantages can be obtained if the intermediate image is “essentially centered” around the optical axis of a subsystem. A centered field requires the smallest possible diameter for which the subsystem must be corrected for image aberrations. Therefore, systems having moderate diameters of optical elements in relation to the numerical aperture can be obtained. If a circular field centered on the optical axis is used, the field has the symmetry of the image aberrations which greatly facilitates correction. Irrespective of the shape of the field the maximum field diameter for which the optical system must be corrected has its minimum for a centered field. If the field is decentered with respect to the optical axis by a lateral offset between the optical axis and the center of the field the minimum diameter for which the system must be corrected increases gradually as the offset distance increases. In this regard, a field will be regarded as “essentially centered” around an optical axis if a lateral offset distance between the optical axis and the center of the field is less than 10% or less than 20% of the diameter of the field in the direction of the offset.

A particular embodiment has an angular offset between the first and second optical axis. The first optical axis is tilted with respect to the second optical axis by a tilt angle to form an axis intersection point and the intermediate image is formed in a curved intermediate image surface having a center of curvature on one of the first and second optical axis. The intermediate image surface may be spherical or at least approximated by a sphere. Preferably a tilt angle T is 0°<T<90°. It has been found that an optical interface formed by a spherical or at least approximately spherical intermediate image between two relatively tilted imaging subsystems can be utilized to obtain optical imaging systems having a flat image field and using a minimum of optical material for its construction. Such optical interface may be provided between a first imaging subsystem having an off-axis object and image field and a second imaging subsystem having an essentially centered object field. The first imaging subsystem can be constructed using one ore more concave mirrors providing strong Petzval overcorrection for the intermediate image and the second imaging subsystem can be constructed purely refractive to obtain high image end numerical aperture. No correcting means for correction of field curvature need to be provided in the dioptric subsystem, thus allowing to built a dioptric imaging subsystem that is axially compact, has a small number of lenses and wherein the maximum lens diameters are moderate.

Preferably, the center of curvature of the curved intermediate image surface lies on or in the vicinity of the axis intersection point of first and second optical axis. In this case, a flat image can be obtained.

In order to obtain an image of the object field free of vignetting it is preferable that the exit pupil surface of the first imaging subsystem and the entrance pupil surface of the second image subsystem essentially coincide with regard to size shape and location. In systems having relatively tilted first and second optical axis it is preferable that the exit pupil surface and the entrance pupil surface are positioned in the vicinity of the axis intersection, which in turn may be positioned close by or at the center of curvature of a curved intermediate image surface. A particularly relaxed construction of the optical subsystems can be obtained this way.

In other embodiments there is a parallel offset between the first optical axis and the second optical axis. The intermediate image may be arranged essentially centered with respect to one of the optical axes, particularly the second optical axis, and eccentrically or off-axis with respect to the other optical system. Under these conditions, a catadioptric or catoptric first optical subsystem having at least one concave mirror and a dioptric second optical subsystem can be combined having parallel optical axes. The advantage of catoptric or catadioptric subsystems regarding correction of Petzval sum and regarding the absence of color aberrations can be combined with compact, dioptric subsystems providing a desired reduction ratio and high image side numerical aperture.

It is also possible that both imaging subsystems linked together at the intermediate image are catadioptric or catoptric including at least one concave mirror. The catadioptric or catoptric subsystems may be linked together at an intermediate image, which is off-axis with respect to both the optical axis of the first subsystem and the optical axis of the second subsystem.

For the concatenation of optical systems there must be an intermediate image present inside the system. The optical elements having a real object forming an intermediate image or a final image are grouped together to form a subsystem. There can be more than two subsystems in the structure of an optical system. A subsystem can be pure refractive including only refractive optical elements, catadioptric, combining refractive elements with curved mirrors, or pure reflective, containing only mirrors.

Also, depending on the distribution in space of the subsystem optical axes, inline systems without folding mirrors and folded systems including one or more planar folding mirrors are possible.

This invention applies to all possible combinations of subsystems, dioptric, catadioptric or pure reflective folded or inline.

The previous and other properties can be seen not only in the claims but also in the description and the drawings, wherein individual characteristics may be used either alone or in sub-combinations as an embodiment of the invention and in other areas and may individually represent advantageous and patentable embodiments.

### BRIEF DESCRIPTION OF THE DRAWINGS

FIG. 1 shows an embodiment of a catadioptric imaging system according to the invention having one catadioptric and one dioptric subsystem with relatively tilted optical axes and curved intermediate image surface;

FIG. 2 shows a schematic representation of a catadioptric imaging system having two catadioptric subsystems with parallel offset optical axes;

FIG. 3 shows a schematic representation of a variant of the system of FIG. 2 where the catadioptric subsystems are tilted at a non-rectangular angle with respect to the object side and image side optical axis;

FIG. 4 shows a variant of the system of FIG. 2 having an axial image field;

FIG. 5 shows a schematic representation of a catadioptric imaging system with two coaxial concave mirrors with off-axis object field and a centered refractive focusing group;

FIG. 6 shows a variant of the system of FIG. 5 where the optical axes defined by the concave mirrors are relatively tilted to the image side optical axis and where a curved intermediate image is formed between the catadioptric subsystems and the refractive focusing group;

FIG. 7 shows a variant of the system of FIG. 2 having a refractive relay system between object surface and the first catadioptric subsystem with off-axis object field and image field;

FIG. 8 shows a variant of the system of FIG. 7 with an axial object field and an off-axis image field;

FIG. 9 shows a variant of the system in FIG. 7 or 8 having an off-axis object field and an axial image field;

FIG. 10 shows a variant of the system shown in FIG. 3 with a refractive relay system inserted between object surface and the first catadioptric subsystem;

FIG. 11 shows a variant of the system shown in FIG. 6 with a refractive relay system inserted between object surface and the first catadioptric subsystem;

FIG. 12 shows a variant of the system shown in FIG. 5 with a refractive relay system inserted between object surface and the first catadioptric subsystem;

FIG. 13 shows a schematic representation of a catadioptric imaging system with two intermediate images and a centered refractive focusing group;

FIG. 14 shows a variant of the system of FIG. 13 where the optical axis of the catadioptric subsystem is tilted at a non-rectangular angle with respect to the object side and image side optical axis;

FIG. 15 shows a variant of the system of FIG. 13 having axial object field and image field;

FIG. 16 shows a variant of the system of FIG. 13 where beam paths to and from the concave mirror cross each others;

FIG. 17 shows a schematic representation of a catadioptric imaging system having a folding mirror within a refractive subsystem and a lens group between the folding mirror and a field surface close to the folding mirror;

FIG. 18 shows a schematic representation of another embodiment of a catadioptric imaging system having a folding mirror within a refractive subsystem and a lens group between the folding mirror and a field surface close to the folding mirror;

FIG. 19 shows a schematic representation of an in-line catadioptric system having off-axis object field and image field arranged side by side;

FIG. 20 shows schematically a variant of the system shown in FIG. 19;

FIG. 21 shows schematically a variant of the system of FIG. 19 having parallel object surface and image surface;

FIG. 22 shows schematically a catadioptric system having a dioptric second subsystem preceded by a catadioptric chromatic corrector having about unit magnification;

FIGS. 23 and 24 show schematically variants of catadioptric systems having an entry side Offner-type catadioptric subsystem and an image side refractive focusing subsystem.

### DETAILED DESCRIPTION

In the following description of preferred embodiments of the invention, the term “optical axis” shall refer to a straight line or sequence of straight-line segments passing through the centers of curvature of the optical elements of an optical subsystem. The optical axis may be folded by folding mirrors (deflecting mirrors) or other reflective surfaces. In the case of the examples presented here, the object is either a mask (reticle) bearing the pattern of an integrated circuit or some other pattern, for example, a grating pattern. In the examples presented here, the image of the object is projected onto a wafer arranged in the image plane serving as a substrate that is coated with a layer of photoresist, although other types of substrate, such as components of liquid-crystal displays or substrates for optical gratings, are also feasible.

Where appropriate, identical or similar features or feature groups in different embodiments are denoted by similar reference identifications. Where reference numerals are used, those are increased by 100 or multiples of 100 between embodiments.

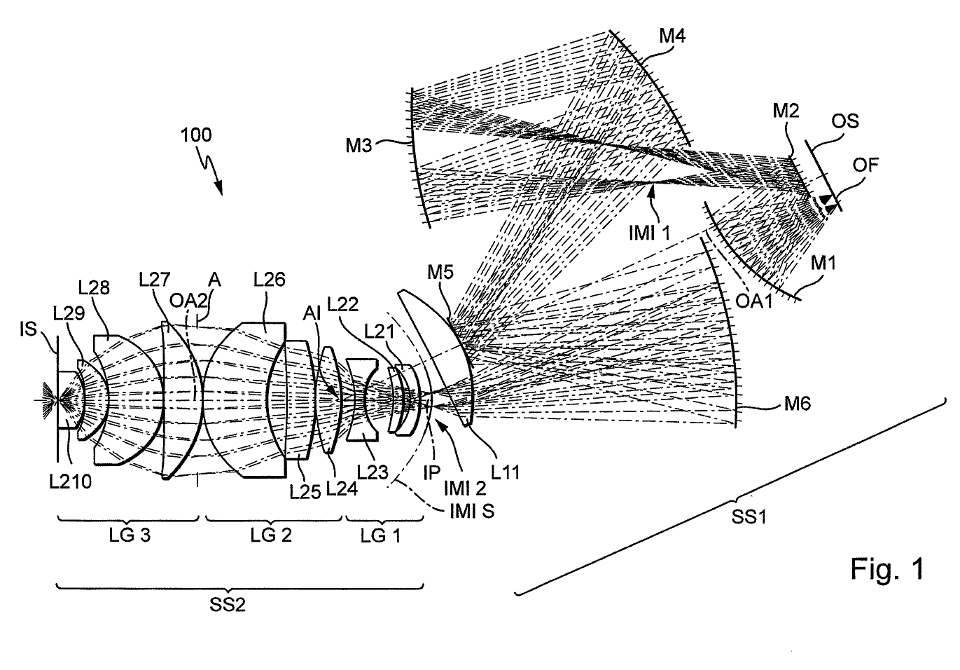

FIG. 1 shows a lens section of an imaging system 100 designed as a catadioptric projection objective for microlithography. The imaging system is designed to project an image of a pattern on a reticle arranged in the planar object surface OS onto the planar image surface IS on a reduced scale of about 4:1 while creating two real intermediate images IMI1 and IMI2. A first catadioptric imaging subsystem SS1 is provided for receiving radiation coming from the object surface and for creating the intermediate image IMI2, while creating one further intermediate image IMI1 prior to forming the intermediate image IMI2. A second, dioptric imaging subsystem SS2 is provided for imaging the intermediate image IMI2 directly, i.e. without a further intermediate image, onto the image surface IS. The first imaging subsystem SS1 has a first optical axis OA1 which is tilted by about 25° with respect to the second optical axis OA2 of the second imaging subsystem. The relatively tilted optical axes OA1, OA2 intersect and an axis intersection AI on the second optical axis between intermediate image IMI2 and image surface IS. Note that no folding mirror is present at the axis intersection, which shows that there are two different optical axes OA1 and OA2. The intermediate image extends in an intermediate image surface IMIS (dashed line) having an essentially spherical curvature with a center of curvature on the second optical axis in the vicinity of the axis intersection AI.

The first optical subsystem SS1 is a catadioptric subsystem including six curved mirrors M1 to M6 and one positive lens L11. The surfaces of curvature of all curved mirrors of the first imaging subsystem have a common axis of rotational symmetry coinciding with the first optical axis OA1. An axially symmetric optical system, also named coaxial system, is provided this way. The object field OF and image field (formed by intermediate image IMI2) of the catadioptric subsystem SS1 are off-axis, i.e. positioned at a radial distance from the first optical axis OA1. The subsystem SS1 has a circular pupil centered around OA1 at the fifth mirror M5.

The second optical subsystem SS2 is purely dioptric with ten lenses L21 to L210 centered around to the optical axis OA2. The intermediate image IMI2 formed by the first subsystem SS1 is arranged off-axis, i.e. at a radial distance from the first optical axis OA1, but is perfectly centered around the second optical axis OA2 of the refractive subsystem SS2.

Radiation emitted from the off-axis object field strikes the first concave mirror M1 having a mirror surface facing the object surface and is reflected to mirror M2 having a convex mirror surface facing image wise. Radiation reflected from second mirror M2 forms the off-axis intermediate image IMI1 within the first subsystem SS1 prior to striking on the concave mirror surface of mirror M3 facing the object side, from where it is reflected to concave mirror M4 having an image side reflecting surface. Radiation reflected from mirror M4 is reflected inwardly to mirror M5 having a concave reflecting surface intersecting the first optical axis, from where radiation is reflected to mirror M6 arranged on the object field side on the optical axis OA1 for converging the radiation towards the intermediate image IMI2. The radiation is converged and deflected by positive refractive power of lens L11 prior to forming the intermediate image IMI2.

The second imaging subsystem SS2 serves as main focusing group of the projection objective 100. The dioptric subsystem SS2 can be subdivided into a first lens group LG1 following the object surface IMIS of the subsystem and having moderate negative refractive power, a second lens group LG2 immediately following and having positive refractive power and a third lens group LG3 having positive refractive power. An aperture stop A can be positioned between the second and third lens group in the vicinity of an axial position where the chief ray intersects the second optical axis.

The catadioptric imaging system 100 is an example of how to design an imaging system having large etendu and very high image side numerical apertures, particularly those suitable for immersion lithography at NA>1, with a very small amount of transparent optical material. One contribution to this goal is to optimize the main focusing group (formed by the second imaging subsystem) as small as possible with regard to axial length as well as to maximum lens diameter. Certain technical measures contribute to achieving this goal. Firstly, the main focusing group SS2 has a field that is centered on the optical axis OA2. This gives the best possible etendue and the best performance. These advantages are gradually diminished as the object field (corresponding to the intermediate image IMI2) is decentered with respect to the second optical axis. Secondly, the second subsystem SS2 should have no or little Petzval correction and should be almost all positive power. Since asking for Petzval correction is the hardest task for a refractive design, much better performance results when this requirement is dropped. The absence of optical means for correcting Petzval sum implies that the long conjugate input of the second subsystem (i.e. the system side facing the intermediate image) should be curved concavely to the image side in order to obtain a flat image in the image surface IS. Further, there should be no requirement about the telecentricity of the second subsystem on the long conjugate end (at IMI2).

The second subsystem SS2 shows typical features of refractive imaging subsystems designed observing this rules. Subsystem SS2 is designed to image an essentially spherically curved intermediate image surface having a center of curvature on the image side onto a flat image surface IS optically conjugate thereto without intermediate image. An image curvature is introduced by the second subsystem, the absolute value of the corresponding Petzval radius corresponding to the radius of curvature of the intermediate image surface IMIS, which is about 152 mm in the embodiment. Preferably, the radius of curvature is less than 100% or 80% or 50% or even less than 40% or 30% of the track length (axial distance between IMIS and IS) of the dioptric subsystem SS2). No optical means for Petzval sum correction are employed in the refractive system SS2, thereby obtaining an optical system being compact an axial direction and having a low number of lenses with moderate maximum diameter. It is evident that only the first lens group LG1 includes lenses L21, L23 having negative refractive power, where the diameters of these lenses are small. The overall refractive power of LG1 is weakly negative and adapted to transform the radiation coming from the curved intermediate image surface into a divergent beam bundle entering the positive lens groups downstream LG1. All other lenses (L23-L210) are positive lenses. Avoiding negative lenses behind the first lens group contributes to obtaining small lens diameters since any diverging action of a lens would have to be compensated for by a stronger positive power downstream thereof. At the same time, the number of lenses is only ten, which is small compared to refractive projection objectives having comparable image side numerical aperture and magnification. Dioptric subsystems having almost no means for Petzval sum correction may be characterized by high values for parameter P=E/N, where E is the etendue (product of image side NA and image field size) and N is the number of lenses. The second subsystem SS2 has NA=1.1 when used as an immersion lens, and has 4:1 reduction ratio. The field size is 26·5.5 mm² and the axial length is only 590 mm. The largest lens clear aperture is 240 mm diameter. A wavefront is corrected at 8 mλ (RMS) over the field having low numerical aperture (at the intermediate image IMI arranged in the spherically curved intermediate image surface). Eight aspheric surfaces are used in the example. Light loss is low since there are only 20 optical surfaces.

The compact, low mass, all refractive second imaging subsystem SS2 is combined with the catadioptric imaging subsystem SS1 that is adapted for providing the Petzval overcorrection in order to obtain a spherically curved intermediate image surface needed to reduce mass and size of the second subsystem SS2. The catadioptric subsystem SS1 has only one truncated positive lens L11, that is very little transparent material. In other embodiments, the subsystem providing the Petzval overcorrection is all reflective, i.e. a catoptric system.

Since concave mirrors are used to provide Petzval sum overcorrection a problem arises since the field of the mirror system must be off-axis when an imaging free of obscuration and vignetting is desired. The refractive second subsystem, in contrast, is preferably used such that the field is centered around the second optical axis. In order to fulfill these seemingly contradictory requirements the embodiment of FIG. 1 uses the concept of angularly offsetting first and second optical axes with respect to each other at the intermediate image. The system is designed to create a special situation where it is possible to combine a refractive focusing group with the field centered about the axes with a catadioptric group that is used off-axis. In order to allow this, the two subsystems SS1 and SS2 are independently well corrected for all imaging errors except for Petzval sum. Then the only reason for adding the catadioptric subsystem SS1 to the overall imaging system is to “fix” the Petzval curvature of the refractive subsystem to make the combined system 100 telecentric on both ends. The catadioptric subsystem preferably has magnification close to unity such that the entire reduction is determined by the reduction ratio of the second subsystem (i.e. 4:1). Therefore, in this particular embodiment, the only aberration compensation between the two subsystems SS1 and SS2 is the Petzval sum and nothing else.

Further conditions allowing an imaging free of vignetting are also observed. The pupils of the first subsystem SS1 and the second subsystem SS2 match up at the intermediate image IMI2 not just in axial position, but laterally too. This is made possible in the embodiment by designing the subsystems such that each of the two systems has its pupil surface in the vicinity of the center of curvature of the curved intermediate image surface.

Due to the tilting of the second optical axis OA2 with respect to the first optical axis OA1 the two subsystems are not co-axial and the object surface OS is not parallel, but at an angle ±90° to the image surface IS. The mounting of the lenses and mirrors must account for the angular offset of the optical elements. A planar folding mirror could be employed to arrange the object and image surface parallel to each other, if desired. Another problem is that it may be quite difficult to correct the subsystems SS1 and SS2 separately for lateral color. Therefore, in a preferred embodiment projection objective 100 is used in a projection exposure system having a laser light source with very narrow bandwidth, preferably smaller than 0.3 pm.

Although one underlying concept is that the only aberration that cancels between the two subsystems is Petzval curvature, a perfect optical link between the subsystems can also be obtained if there is a finite amount of a spherical aberration between the two systems since the spherical aberrations is constant over the field.

Even more generally speaking, an optical link between the two subsystems having relatively offset optical axes is possible without introducing image errors due to the offset if the off-axis field created by the first subsystem SS1 has imaging errors that are symmetrical to the second optical axis OA2.

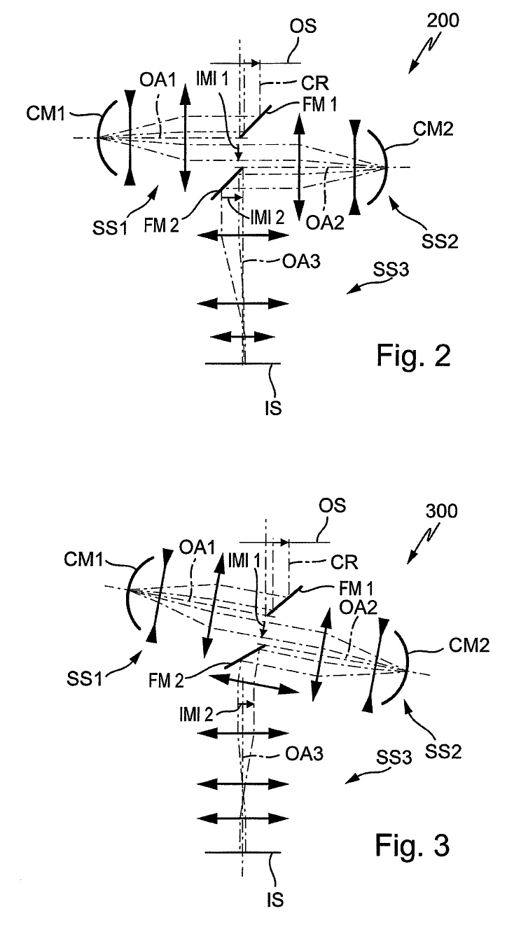

In the following FIGS. 2 to 18 further embodiments of catadioptric projection objectives for microlithography according to the invention are shown. In the schematic representations the optical axes of imaging subsystems are characterized by dash-dotted lines. Each system contains one or more concave mirrors, a concave mirror being symbolized by segment of a circle. Where planar folding mirrors are employed, these are symbolized by a straight line segments. Single lenses or lens groups having overall positive refractive power are symbolized by double arrows having their arrow heads facing outside. Single lenses or lens groups having overall negative refractive power are symbolized by double arrows having arrow heads facing inwards. An object or intermediate image or final image defining a field surface is symbolized by an arrow perpendicular to a respective optical axis. The imaging process is symbolized by a continuous line representing the chief ray CR emerging from an off-axis object point in the case of telecentricity parallel or at a small angle with respect to the optical axis at the object. Pupil surfaces are disposed axially between field surfaces at axial positions where the chief ray CR intersects an optical axis.

In all embodiments of FIGS. 2 to 18 the concave mirrors are positioned in the vicinity of pupil surfaces, similar to Dyson-type catadioptric imaging systems (compare J. Dyson, “Unit Magnification Optical System without Seidel Aberrations”, Journal of the Optical Society of America, Vol. 49, No. 7 (July 1959) p.p. 713-716).

Some embodiments are characterized by a parallel offset of imaging subsystems upstream and downstream of an intermediate image, where the offset occurs at an intermediate image. The amount of lateral offset in each case is selected such that requirements with regard to installation space can be relaxed for critical optical elements, such as folding mirrors, without loss of optical performance. Optimization of positioning a mirror with respect to a high aperture beam bundle in the vicinity of an intermediate image can also be utilized to decrease the objective field radius which has to be corrected for a given numerical aperture and and/or to increase etendue without introducing problems of vignetting.

Other embodiments include tilted optical axes of imaging subsystems upstream and downstream of the intermediate image. This is a consequence of the intermediate image curvature.

The catadioptric projection objective 200 includes a first imaging subsystem SS1 having a concave mirror CM1 for creating a first intermediate image IMI1 from radiation coming from the object field OF. A first planar folding mirror FM1 inclined with respect to the optical axis OA1 by 45° and arranged on the object field side of OA1 is provided such that a part of the first optical axis OA1 on the symmetry axis of the concave mirror CM1 extends perpendicularly to the part of the first optical axis intersecting the object surface OS. A second imaging subsystem SS2 including a second concave mirror CM2 is provided for imaging the first intermediate image IMI1 into a second intermediate image IMI2. The axis of symmetry of the second concave mirror CM2 defines a mirror part of the second optical axis OA2, which runs parallel, but laterally off-set with respect to the mirror part of the first optical axis OA1 at the first intermediate image IMI1. A second folding mirror FM2 parallel to the first folding mirror FM1 and situated on the opposite side of the optical axis OA1 as first folding mirror FM1 is provided for guiding radiation coming from the second concave mirror CM2 to the image surface IS, whereby the second optical axis OA2 is folded such that an image side part thereof runs parallel but offset to the object side part of the first optical axis. A third imaging subsystem SS3 serves as a focusing group to image the second intermediate image IMI2 onto the image surface at a reduce scale.

The first catadioptric subsystem SS1 has a magnification near unity, so that the first intermediate image IMI1 is similar in size to the object. Also the first intermediate image is almost flat, that means it is free of field curvature. So, the first subsystem acts in fact like a relay system. The second subsystem SS2 has also a magnification near to unity, and forms an intermediate image IMI2 with strong Petzval curvature overcorrection due to the concave mirror CM2 and the negative lens group in front of it, in order to compensate the undercorrection of the third pure refractive subsystem SS3. The third subsystem can also be a relay system forming an image similar in size as his object or can have a magnification or demagnification function. Since the sections of the first optical axis OA1 and the second optical axis OA2 defined by the respective concave mirrors CM1 and CM2 are laterally offset at the first intermediate image IMI1 the high aperture beam bundle can be fitted through the space between the folding mirrors FM1, FM2 without vignetting. The lateral offset provides degrees of freedom within the installation space for the folding mirrors. Intermediate image IMI2, which is the object of dioptric subsystem SS3, decentered with respect to the optical axis OA3 thereof.

The projection objective 300 of FIG. 3 has the same subsystem types and number as the embodiment of FIG. 2. There are two major differences to that embodiment. First, the third subsystem SS3 has an axial field. Second, the third subsystem SS3 having optical axis OA3 is tilt positioned with respect to the folded optical axis OA2 of the second subsystem SS2. This small angle, non-rectangular tilt is not due to the folding mirror FM2 but to the curvature of the second intermediate image IMI2. These properties of the intermediate image IMI2 allow an optimal position setup for the third subsystem SS3 relative to the object field of this subsystem, strongly reducing the etendue of this subsystem.

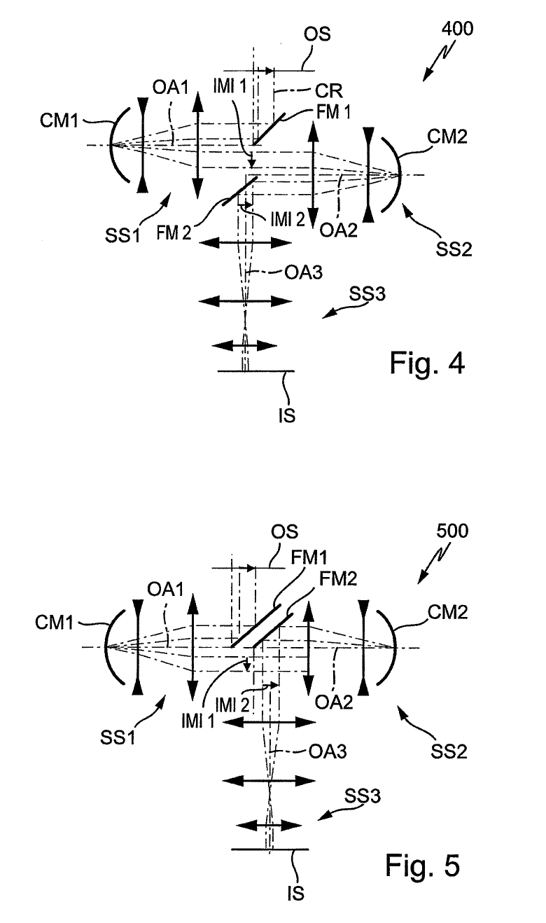

The system configuration of the projection objective 400 FIG. 4 permits another aberration distribution in the intermediate images. Here the second intermediate image IMI2 is almost flat. In this configuration there is no tilt between the optical axis OA2 and OA3.

Intermediate solutions forming a compromise between the features of the exemplary systems shown in FIGS. 2, 3 and 4 are also possible. Particularly, it is evident that the amount of decentering of the object of the third, dioptric subsystem SS3 (formed by the second intermediate image IMI2) can be selected to have any particular value of decentering between perfect centering (FIG. 3) and an off-axis situation (FIG. 2). Also, the lateral offset between the first and the second optical axis at the first intermediate image can be selected as needed. These selections can be made without significant loss of imaging performance if the first to fifth conditions mentioned above are observed as close as possible.

The projection objective 500 shown in FIG. 5 has a similar construction as the system in the embodiment presented in FIG. 4. However, there is no offset between the optical axis OA1 and OA2 and also there are no conditions on the quality of the first intermediate image IMI1. The third subsystem SS3 still has an axial field.

A first optical path running from the object surface OS via the first concave mirror CM1 to the second concave mirror CM2 and a second optical path running from second concave mirror CM2 to the image surface IS cross each other shortly downstream of the reflection at the second folding mirror FM2. A crossed beam path of this type can be utilized to relax construction space constraints in the region of the folding mirrors and to obtain high etendue values. With regard to the crossing of beam path in catadioptric objectives, references made to U.S. patent application Ser. No. 10/734,623, which is a continuation-in-part application to U.S. patent application Ser. No. 09/751,352 filed on Dec. 27, 2002. The contents of these documents is incorporated into this specification by reference.

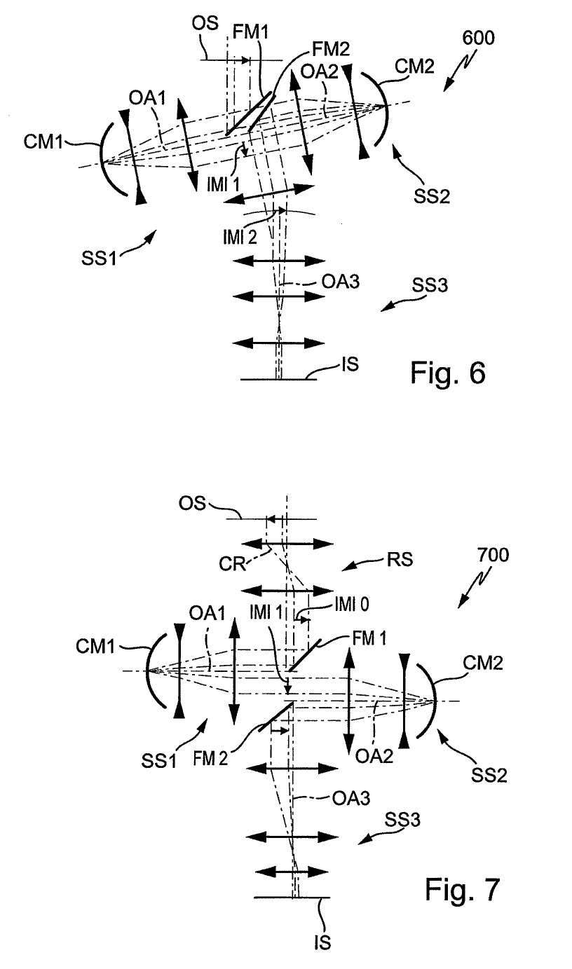

Another embodiment 600 is presented in FIG. 6. Using a similar structure as the aforementioned embodiment, the two subsystems SS1 and SS2 are sharing a common optical axis and are forming an intermediate image IMI2 strongly affected by overcorrected Petzval field curvature. With this overcorrection the undercorrection of the third subsystem SS3 is compensated.

Making the field for the third subsystem SS3 to be an axial field implies that the optical axis OA3 of the third subsystem must be tilted to the folded optical axis OA2 of the second subsystem SS2. Using the first folding mirror FM1 with a mplanar mirror surface inclined at a small angle (e.g. <30°) to the mirror surface of the second folding mirror one can adjust the tilt angle of this mirror in order to make the final image surface being parallel to the object surface. This also applies to the system in FIG. 3.

In a further embodiment 700 exemplarily shown in FIG. 7 the beam folding situation at the folding mirrors FM1 and FM2 can further be relaxed with respect to the embodiments of FIG. 2 to 6. The further relaxation is obtained by a refractive relay system RS which is inserted between the object surface OS and the field surface immediately upstream of the first folding mirror FM1. This field surface forms the object surface in FIGS. 2 to 6, whereas in the embodiments according to FIGS. 7 to 18 the field surface immediately upstream of the first folding mirror FM1 is an intermediate image IMI0 formed by a refractive relay system RS from the object field OF.

The projection objective 700 in FIG. 7 is a variant of the projection objective of FIG. 2 where all optical elements downstream of the intermediate image IMI0 formed by the relay system RS are identical to those of FIG. 2. Therefore, reference is made to that description. Whereas a certain axial distance between the object surface and the first folding mirror FM1 is necessary in the embodiment of FIG. 2 to avoid collision between a reticle stage for handling the reticle placed in the object surface and the mirrors of the catadioptric groups, this problem is avoided if a relay system RS as shown in FIG. 7 is inserted between the object surface and the catadioptric groups. Thereby, the intermediate image IMI0 forming the object for the first catadioptric subsystem SS1 can be positioned closer to the first folding mirror FM1 which allows, amongst others, for larger etendue when compared to systems as shown in FIG. 2.

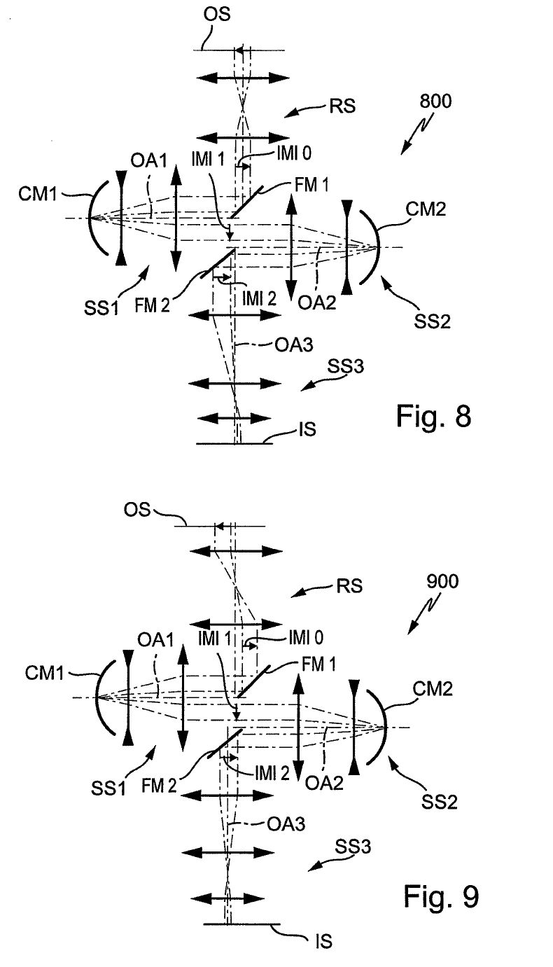

The embodiment 800 of FIG. 8 is a variant of the projection objective 700 of FIG. 7. The main difference is that the relay system RS forms a flat intermediate image IMI0. As a consequence the object field for the first subsystem can be configured as an axial field, thereby significantly reducing the etendue of the first subsystem. This type of relay-system RS can also be implemented in the objectives presented as preferred embodiments 900 to 1200.

The embodiment of FIG. 9 is a variant of the embodiment 300 of FIG. 3. The only difference is that there is a first refractive relay system RS positioned between the object surface and the first catadioptric subsystem.

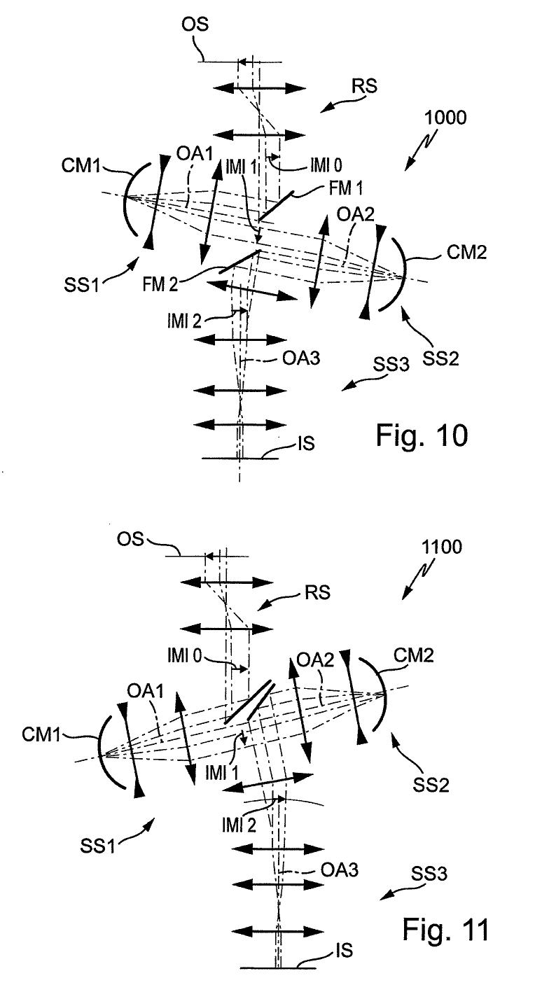

The embodiment 1000 of FIG. 10 is a variant of the embodiment 400 of FIG. 4 with the same difference as embodiment 900.

The embodiment 1100 of FIG. 11 is a variant of the embodiment 600 of FIG. 6 with the same difference as embodiment 900.

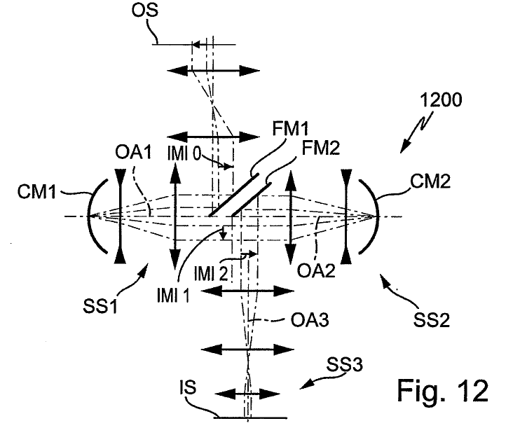

The embodiment 1200 of FIG. 12 is a variant of the embodiment 500 of FIG. 5 with the same difference as embodiment 900.

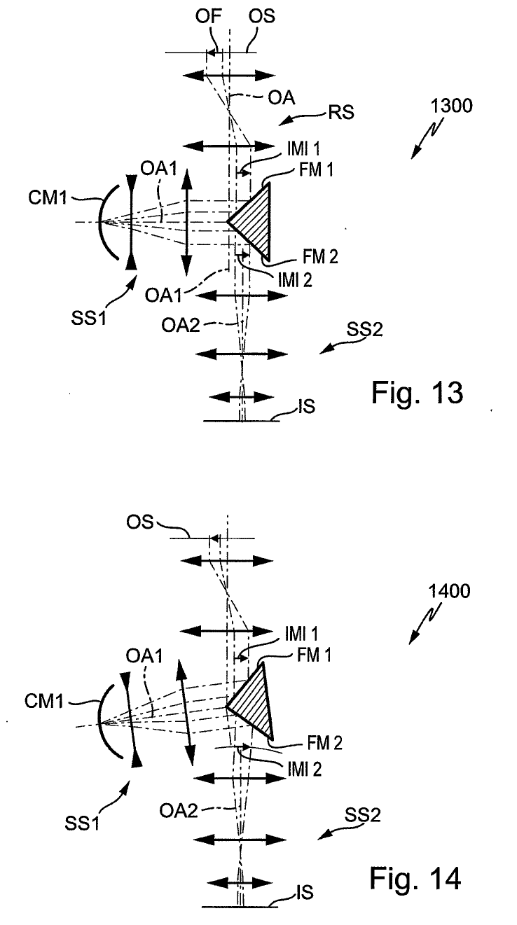

Embodiment of FIG. 12 can be regarded as a variant of an embodiment of a catadioptric projection objective shown in FIG. 13 of U.S. patent application with Ser. No. 10/734,623 mentioned above, or that shown in FIG. 5 of U.S. provisional patent application with Ser. No. 60/511,673 filed on Oct. 17, 2003. These documents are incorporated herein by reference. The concept of introducing lateral offset between optical axes adjacent to an intermediate image can be introduced to all embodiments shown in that patent applications.

One characterizing feature of the embodiments shown in FIGS. 2 to 12 is that these embodiments comprise a first catadioptric imaging system having a first concave mirror for creating an intermediate image, a second catadioptric imaging system having a second concave mirror for creating a further intermediate image from that intermediate image, and a refractive imaging subsystem for imaging that intermediate image onto the image plane, wherein the segments of the optical axes of the catadioptric subsystems symmetric to the concave mirrors are parallel to each other and the optical axis of the refractive system is at an angle, particularly perpendicular thereto such that a cross-shape is obtained, wherein at least two of the optical axes forming the cross-shape are laterally offset with respect to each other at an intermediate image formed therebetween. Whereas exactly two intermediate images are formed in the embodiments of FIGS. 2 to 6, exactly three intermediate images are formed in the embodiments of FIGS. 7 to 12 due to the additional dioptric relay system RS introduced between the object surface and the first catadioptric subsystem.

The invention can also be implemented in catadioptric imaging systems having, in that sequence, a refractive imaging subsystem forming an intermediate image from the object field, a catadioptric imaging subsystem including one concave mirror for imaging that intermediate image onto a subsequent intermediate image, and a refractive subsystem for imaging that intermediate image onto the image surface. Systems of this type are also denoted RCR-system in the following, where R denotes a refractive and C denotes a catadioptric imaging subsystem. Catadioptric projection objectives of this type having optical axes of the imaging subsystems coinciding at the intermediate images are disclosed, for example, in the patent applications EP 1 191 378 A1, WO 2004/019128 A, WO 03/036361 A1 or US 2003/0197946 A1.

FIG. 13 shows an embodiment of a catadioptric projection objective 1300 of R-C-R type featuring a lateral offset of optical axes of subsequent imaging systems at an intermediate image formed therebetween for improvement of construction and optical performance. The imaging system 1300 has a refractive relay system RS with an optical axis OA for forming an intermediate image IMI1 from an object field OF which is decentered with respect to the optical axis OA. A catadioptric first imaging subsystem SS1 including a concave mirror CM1 is provided for imaging the intermediate image IMI1 into a second intermediate image IMI2 downstream of the concave mirror. A second, refractive imaging subsystem SS2 is provided for imaging the intermediate image IMI2 onto the image surface IS. A first folding mirror FM1 inclined at 45° to the optical axis is provided to guide the radiation from the object field towards the concave mirror CM1. The optical axis OA is folded at the folding mirror FM1. The concave mirror CM1 is arranged such that the symmetry axis of the concave mirror forming the first optical axis OA1 is coaxial with the optical axis OA of the relay system RS at IMI1. A second folding mirror FM2 perpendicular to the first folding mirror FM1 is provided to guide the radiation reflected from the concave mirror CM1 to the image surface. The second folding mirror FM2 is arranged optically inside the catadioptric first subsystem SS1 immediately upstream of the intermediate image IMI2, thereby folding the first optical axis OA1 to create a section of this optical axis which is parallel to the optical axis OA2 of the second, refractive system SS2.

The optical axes OA1 of the catadioptric subsystem and OA2 of the dioptric focusing group are laterally offset at the intermediate image IMI2 such that the intermediate image, which is off-axis with respect to the optical axis OA1 of the catadioptric subsystem, is an axial field for the refractive second subsystem SS2. The second optical axis OA2 is parallel, but laterally offset with respect to the object side optical axis OA of the relay system RS. Introducing the lateral offset allows to use the refractive focusing system SS2 with an axial field, which allows to build this subsystem with minimum size and optical material mass. At the same time, the catadioptric subsystem SS1 can be used off-axis to avoid vignetting of the beam.

Many useful variants can be obtained from R-C-R systems having an offset or tilt between optical axes of subsequent imaging subsystems linked together at an intermediate image.

The embodiment of FIG. 14 relates to a projection objective 1400 of the type described in connection with FIG. 13, that has a certain amount of field curvature present in the second intermediate image IMI2. As a consequence a tilt between the folded optical axis OA1 of subsystem SS1 and the optical axis OA2 of subsystem SS2 must be introduced. The parallelism between the object and image surfaces can be adjusted by the first folding mirror FM1. No restrictions are applied on the first intermediate image.

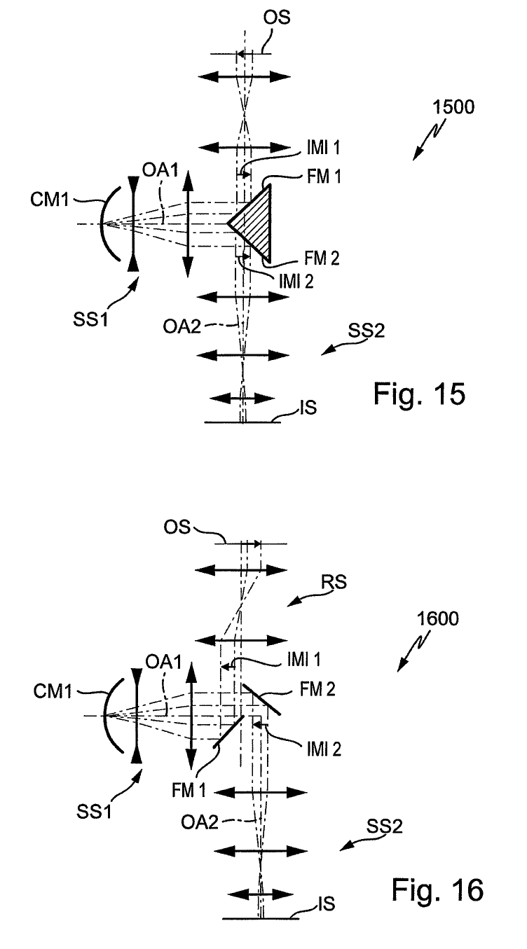

The embodiment 1500 of FIG. 15 relates to a system which has a first and second intermediate image mainly free of field curvature. This setup allows the positioning of the object and the second intermediate image as axial fields for the subsystems downstream the object and the second intermediate image respectively, significantly reducing the etendue and implicitly the dimensions of these subsystems. The second subsystem is still used off axis to avoid vignetting.

The projection objective 1600 of FIG. 16 uses a different folding geometry compared to FIGS. 13, 14 and 15, thus allowing a crossing of a first beam path from the object field to the concave mirror CM1 and a second beam path between the concave mirror CM1 and the image field. By doing so, the second folding mirror FM2 can be placed geometrically between the first folding mirror FM1 and the object surface. The crossing of the beam path allows to construct systems being compact in axial distance between the parallel object and image surface. Also, large entendu can be transferred through the system. Like in the embodiment of FIGS. 13, 14, 15, the intermediate image IMI2 lies off-axis with respect to the optical axis OA1 folded at the second folding mirror FM2, but centered with respect to the optical axis OA2 of the refractive second subsystem SS2.

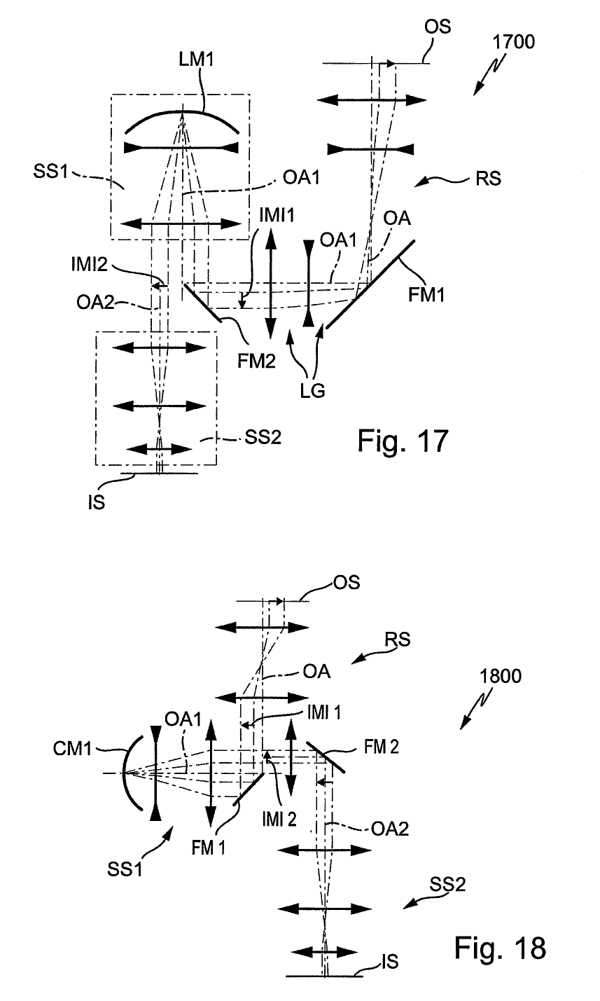

The catadioptric projection objective 1700 shown in FIG. 17 is a variant of a projection objective shown in FIG. 2 of U.S. provisional patent application Ser. No. 60/530,622 filed on Dec. 19, 2003 by the applicant and FIG. 18 shows a variant of a system shown in FIG. 4 of that US provisional application. The content of this provisional application is incorporated into this specification by reference.

The embodiments of FIGS. 17 and 18 are similar to the embodiments of FIGS. 13 to 16 insofar as the concatenated image systems include, from the object to the image side, a refractive relay system RS, a catadioptric first subsystem SS1 and a dioptric second subsystem SS2, wherein intermediate images IMI1 and IMI2 are formed between the imaging subsystems. Furthermore, first and second folding mirrors FM1 and FM2 arranged perpendicular to each other are provided to guide radiation.

In contrast to the embodiments of FIGS. 13 to 16, the first folding mirror FM1 in FIG. 9 is arranged within the refractive subsystem RS upstream of the intermediate image IMI1 and refractive power provided by a lens group LG of negative and positive lenses is provided between the first folding mirror and the intermediate image IMI1. In the embodiment of FIG. 18, the second folding mirror FM2 is arranged optically within the second, dioptric subsystem SS2 and positive refractive power provided by a lens group LG is arranged between the intermediate image IMI2 formed by the catadioptric first imaging subsystem SS1 and the second folding mirror FM2.

Refractive power provided by field lenses LG in the immediate vicinity of an intermediate image can be useful for several reasons. For example, the field lenses LG upstream of the intermediate image IMI1 (FIG. 17) can be designed to influence the correction status of this intermediate image such that a favorable construction of the catadioptric and dioptric subsystems SS1 and SS2 downstream of IMI1 can be obtained. In the embodiment of FIG. 18 the angular distribution of radiation impinging of the second folding mirror FM2 can be positively influenced by the field lens LG immediately downstream of the intermediate image IMI2. Reference is made to the above provisional application for further advantages of providing field lenses close to intermediate images in concatenated catadioptric systems.

In the projection objective 1700 the optical axis OA of the relay system RS is folded at the first folding mirror FM1 by 90°. The optical axis OA1 of the catadioptric first subsystem SS1 defined by the symmetry axis of concave mirror CM1 is folded at the second concave mirror FM2. The optical axes OA and OA1 coincide at the intermediate image IMI1 between the relay system RS and the catadioptric subsystem SS1 such that the intermediate image IMI1 lies off-axis to both optical axes OA and OA1. In contrast, the optical axis OA2 of the refractive second subsystem SS2 is parallel offset with respect to the symmetry axis OA1 of the concave mirror CM1 such that the intermediate image IMI2 is positioned centrally with respect to the second optical axis OA2. High performance focusing at large etendue with moderate sized lenses can be obtained this way.

A similar situation is obtained in a imaging system 1800, where the optical axis OA of the relay system RS coincides with the optical axis OA1 of the catadioptric subsystem SS1, which is folded at the first folding mirror FM1. In contrast, the second optical axis OA2, folded at right angles at the second folding mirror FM2, is laterally offset with respect to the symmetry axis OA1 of the concave mirror such that the intermediate image IMI2 formed by the catadioptric subsystem lies essentially centric with respect to the optical axis OA2 of the focusing group SS2. In the crossed beam path of FIG. 18 the second intermediate image IMI2 in the optical train between object and image is positioned geometrically close to the inner edge of the first folding mirror adjacent to the optical axis OA which allows to get a high aperture beam past the first folding mirror without vignetting, whereby large etendue can be transmitted by the optical system 1800. At the same time the refractive focusing group SS2 can be compact and lens mass conserving.

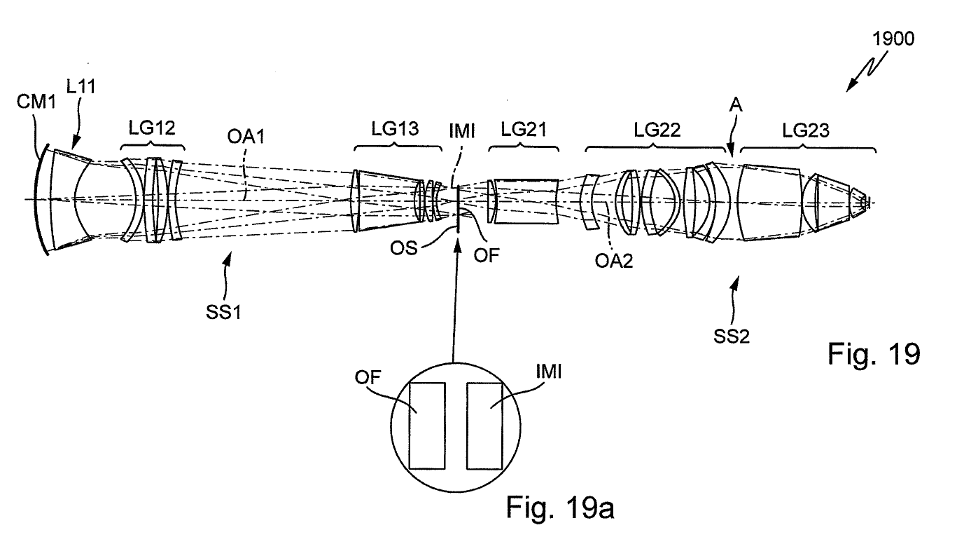

The catadioptric projection objective 1900 in FIG. 19 is an example for a concatenated catadioptric imaging system essentially free of chromatic aberrations using an off-axis object and image field to obtain imaging without obscuration. A first, catadioptric subsystem SS1 including a concave mirror CM1 is used to image the rectangular object field OF into an intermediate image IMI positioned in the vicinity of the object field laterally offset to the object field such that there is no overlap between object field and intermediate image (compare enlarged detail 19(a)). The intermediate image is imaged into the image surface IS by a second, dioptric subsystem SS2. The optical axis OA1 of the catadioptric subsystem and the optical axis OA2 of the dioptric subsystem are co-axial such that an axially symmetric projection objective is obtained.

The system is designed for 193 nm UV-light. The catadioptric subsystem SS1 is designed to provide an overcorrection of chromatic errors at a close to unity magnification such that the rectangular intermediate image has approximately the size of the rectangular object field and is overcorrected for chromatic aberrations. The dioptric subsystem SS2 provides a reduction ratio of about 4:1 and is undercorrected for chromatic aberrations, wherein the undercorrection of the dioptric part is adapted to the overcorrection of the catadioptric part such that the final image in the image surface IS is fully corrected for chromatic aberrations. The two subsystems SS1 and SS2 are linked or connected at the intermediate image IMI which is essentially telecentric.

In the catadioptric subsystem SS1 the chromatic overcorrection is basically obtained by the concave mirror CM1 having positive refractive power and the negative refractive power provided by a negative meniscus lens L11 immediately ahead of the concave mirror. A lens group LG12 consisting of four thin meniscus lenses having pairwise opposite curvature and providing only weak refractive power is provided predominantly for correcting off-axis image aberrations. A third lens group LG13 optically near the object field and intermediate image serves as a field lens group and is optimized for providing a telecentric input and output of the catadioptric subsystem SS1.

The 1:1 catadioptric subsystem SS1 is transited twice by each beam between object field and intermediate image. Telecentricity of the inter-mediate image provides a favorable orientation of the beams with respect to the refractive second subsystem SS2. Since the object field and intermediate image are geometrically separated from each other and positioned almost in a common plane a complete separation of object and image is obtained. Since the catadioptric subsystem provides color overcorrection the dioptric subsystem need not have optical means for color correction. Particularly, all lenses of the dioptric part and all lenses of the catadioptric subsystem are made of the same material (fused silica). The dioptric second subsystem receives the radiation from the almost telecentric intermediate image in a first lens group LG21 which is optimized for bending the chief ray towards the optical axis OA2 to form an aperture position A at the intersection of the chief ray CR with the optical axis. A subsequent group LG22 of thin meniscus lenses having weak refractive power is provided predominantly for correcting off-axis aberrations. Particularly, biconvex “air lenses” formed between an object side meniscus lens having image side concave surface and an image side meniscus lens having object side concave surface are effective for correcting astigmatism. The third lens group LG23 downstream of the aperture position A including thick lenses with positive refractive power provides the high image side numerical aperture NA=0.7 and contributes effectively to the correction of lateral color.

The system of FIG. 19 is designed for 193 nm where all lenses can be made of fused silica. It is also possible to modify the system for 157 nm, where all lenses are preferably made of calcium fluoride.

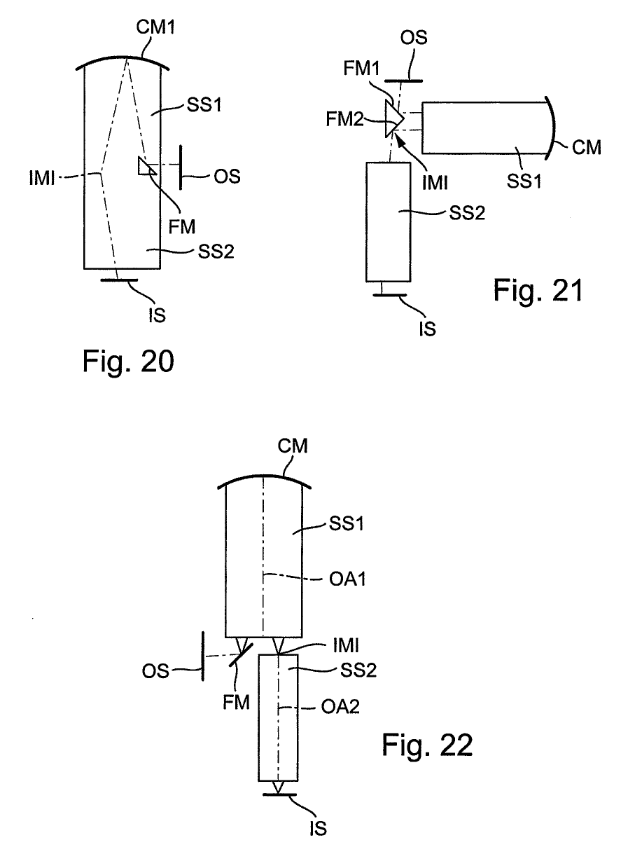

The principle of the concatenated system explained in connection with FIG. 19 can be used in different ways to incorporate a catadioptric projection objective into a microlithographic exposure system, such as a wafer stepper or wafer scanner. In the system of FIG. 19 the object and the image are parallel to each other but it may be difficult to position a reticle in the object surface without interference with the intermediate image. To avoid this problem, it is possible to include a folding mirror FM in the region where the object field is positioned in FIG. 19 to obtain an object field at a suitable distance from the intermediate image. A variant of this type is schematically shown in FIG. 20, where the object surface and the image surface are perpendicular to each other.

However, a parallel situation of object and image surface is desirable particular for use of the catadioptric projection objective in a wafer scanner. A suitable arrangement of the first and second subsystems SS1 and SS2 is schematically shown in FIG. 21. Here a first folding mirror FM1 is provided for deflecting radiation coming from the object field into the first, catadioptric subsystem SS1, which is aligned perpendicularly into the second, dioptric subsystem SS2. A second folding mirror FM2 is positioned in the vicinity of the intermediate image IMI is provided for receiving radiation exiting the catadioptric subsystem prior to entering the dioptric subsystem.

It is possible to fully correct the intermediate image and adapt the dioptric subsystem accordingly. The dioptric subsystem SS2 can then be used as a fully functional projection lens having small chromatic aberration. The projection objective may be used with narrow band width lasers having, for example, a bandwidth <0.3 μm.

The dioptric projection system (designed, for example essentially as shown for the second subsystem SS2 in FIG. 19) can be preceded by an optical subsystem designed as a “chromatic corrector” and having about unit magnification. A schematic representation of a concatenated system of this type is shown in FIG. 22. Here, the optical axis OA1 of the first subsystem acting as a chromatic corrector is parallel off-set with respect to the second optical axis OA2 of the dioptric projection lens, which is arranged such that the intermediate image IMI provided by the first subsystem SS1 lies essentially centered to the optical axis OA2.

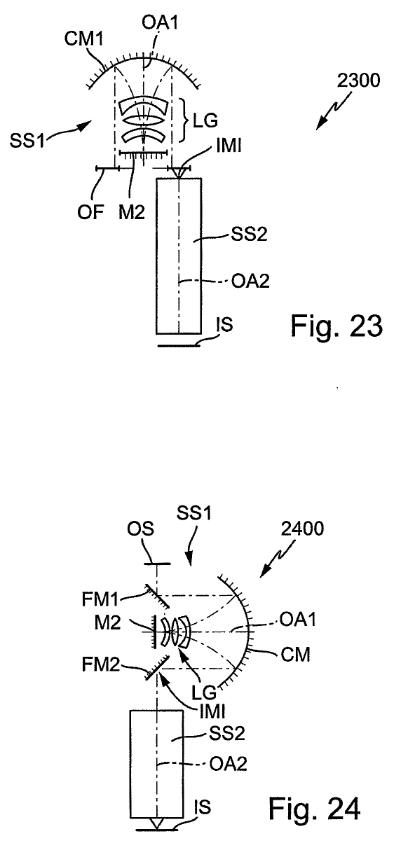

In the following preferred embodiments of chromatic correctors suitable for use in connection with a dioptric subsystem being only partly corrected for chromatic aberrations are shown. In the embodiments of FIGS. 23 and 24 where the second subsystem SS2 in each case is formed by a dioptric reduction lens efficiently corrected for all image aberrations except for chromatic aberration (compare subsystem SS2 in FIG. 19, which can be used for this purpose).

In the catadioptric projection objective 2300 of FIG. 23 the projection subsystem SS2 is complemented by a preceding catadioptric imaging subsystem SS1 designed for creating an intermediate image IMI from the object field OF, wherein the intermediate image is positioned centrically to the optical axis OA2 of the refractive system SS2.

The catadioptric subsystem SS1 is a variant of a unit power Offner type imaging system (compare e.g. U.S. Pat. No. 3,748,015 and U.S. Pat. No. 4,293,186). The system includes a concave mirror CM1 defining the optical axis OA1 and a second mirror M2 placed on the optical axis OA1 at a pupil position between the object field OF and the intermediate image IMI formed by the subsystem. The object field and the intermediate image are positioned in a common plane perpendicular to the optical axis OA1 off-axis thereto and on different sides thereof. Whereas in other Offner type systems the second mirror M2 is a convex mirror, the second mirror M2 may be planar or weakly curved to obtain no or little refractive power. The second mirror M2 is combined with a lens group LG having lenses with predominantly negative refractive power which are passed twice, once between the object field and the second mirror M2 and once between the second mirror and the intermediate image. Subsystem SS1 is designed to provide chromatic overcorrection at the intermediate image IMI which is then compensated by the second subsystem SS2 to obtain a chromatically corrected image.

The refractive subsystem SS2 is centered with respect to the intermediate image IMI, which in turn is placed off-axis with respect to the optical axis OA1 of the catadioptric subsystem such that a lateral offset exists between the optical axes OA1 and OA2 at the intermediate image IMI.

In FIG. 24 a variant of the system 2300 is shown, wherein two planar folding mirrors FM1 and FM2 arranged at 45° with respect to the optical axes OA1 and OA2 are inserted in the optical path in order to obtain axial separation of the parallel object and image surface. The optical axes OA1 and OA2 are offset parallel to each other since the catadioptric subsystem is used off-axis whereas the dioptric subsystem SS2 is used centrically since the intermediate image IMI is centered with respect to OA2.

The Offner type chromatic correcting subsystems SS1 of FIGS. 23 and 24 provide only a ring field. Chromatic correctors constructed in accordance with the principles explained in connection with FIGS. 23 and 24 can be used as “chromatic spectacles” in order to correct chromatically undercorrected imaging systems retroactively, thus allowing for example to use the imaging systems with light sources having larger bandwidth.

The optical subsystems shown in the embodiments can be adjusted and aligned in a rotational symmetric manner with respect to their respective optical axes. Where the optical axes preceding and following the intermediate image coincide (FIGS. 19 and 20) the adjustment extends across entire system, whereas the subsystems have to be adjusted separately where there is an offset between the optical axes upstream and downstream of the intermediate image.

It has been found useful to design the optical system such that intermediate images are positioned at a finite minimum distance between the intermediate image and the next optical surface, which is a mirror surface in many embodiments. If a finite minimum distance is maintained it can be avoided that contaminations or faults on or in the optical surface are imaged sharply into the image plane such that the desired imaging of a pattern is disturbed. Preferably, the finite distance is selected depending on the numerical aperture of the radiation at the intermediate image such that a sub-aperture (footprint) of radiation emerging from an intermediate image point or converging to an intermediate image point on the optical surface next to the intermediate image has a minimum diameter of at least 3 mm or at least 5 mm or at least 10 mm or at least 15 mm.

It is to be understood that all systems described above may be complete systems for forming a real image (e.g. on a wafer) from a real object. However, the systems may be used as partial systems of larger systems. For example, the “object” for a system mentioned above may be an image formed by an imaging system (relay system) upstream of the object plane. Likewise, the image formed by a system mentioned above may be used as the object for a system (relay system) downstream of the image plane.

1. An imaging system comprising:
a plurality of optical elements imaging an object field arranged in an object surface of the imaging system onto an image field arranged in an image surface of the optical system, the optical elements comprising:
a first group of optical elements defining a first optical axis; and
a second group of optical elements defining a second optical axis;
wherein the first optical axis is offset with respect to the second optical axis by an axis-offset such that the first optical axis is not coaxial with the second optical axis; and
wherein the imaging system images an off-axis object field arranged outside the first optical axis in the object surface onto an on-axis image field essentially centered around the second optical axis in the image surface.

2. The imaging system according to claim 1, wherein:
the first group of optical elements forms a first imaging subsystem for creating an intermediate image from radiation coming from the off-axis object field,
the second group of optical elements forms a second imaging subsystem for imaging the intermediate image onto the on-axis image field, and
each of the first optical axis and the second optical axis intersects the intermediate image.

3. The imaging system according to claim 2, wherein the intermediate image has a correction status adapted to the axis-offset such that the correction status of the image field is essentially free from aberrations caused by the axis-offset.

4. The imaging system according to claim 2, wherein:
the first imaging subsystem is a catadioptric or catoptric system including at least one concave mirror and imaging the off-axis object field into the intermediate image situated off-axis with respect to the first optical axis and essentially centered around the second optical axis, and
the second imaging subsystem is a dioptric system imaging the intermediate image onto the image field essentially centered around the second optical axis in the image surface.

5. The imaging system according to claim 2, wherein:
the intermediate image is essentially centered around the second optical axis and defines an intermediate image surface;
the first optical axis intersects the intermediate image surface at an intersection point eccentrically to the second optical axis; and
the intermediate image is corrected for image aberrations such that image aberrations are essentially symmetrical with respect to the intersection point.

6. The imaging system according to claim 1, wherein the first optical axis is tilted with respect to the second optical axis by a tilt angle T with 0°<T<90°.

7. The imaging system according to claim 2, wherein:
the intermediate image is eccentric to the first optical axis,
the second optical axis intersects the intermediate image, and
the intermediate image is corrected for image aberrations such that the image aberrations are essentially symmetrical with respect to the second optical axis.

8. The imaging system according to claim 2, wherein the intermediate image is disposed symmetrical to the second optical axis.

9. The imaging system according to claim 2, wherein:
the first optical axis is tilted with respect to the second optical axis to form an axis intersection point, and
the intermediate image is formed in an essentially spherically curved intermediate image surface having a center of curvature in the vicinity of the axis intersection point.

10. The imaging system according to claim 9, wherein an exit pupil of the first subsystem and an entrance pupil of the second subsystem essentially coincide and are positioned in the vicinity of the center of curvature of the curved intermediate image surface.

11. The imaging system according to claim 9, wherein the second imaging subsystem images the essentially spherically curved intermediate image surface having a center of curvature on the image side of the intermediate image surface onto a flat image surface optically conjugate to the intermediate image surface without forming an additional intermediate image, whereby an image curvature introduced by the second subsystem has an absolute value of a corresponding Petzval radius essentially corresponding to the radius of curvature of the intermediate image surface.

12. The imaging system according to claim 9, wherein:
the second imaging subsystem has a first lens group following the intermediate image surface and having negative refractive power, a second lens group immediately following the first lens group and having positive refractive power, and a third lens group immediately following the second lens group and having positive refractive power, and
an aperture stop position is provided between the second and third lens group in the vicinity of an axial position where a chief ray intersects the second optical axis.

13. The imaging system according to claim 9, wherein the curved intermediate image surface has radius of curvature which is less than at least one of 100% and 80% and 50% and 30% of an axial distance between the curved intermediate image surface and the image surface of the second subsystem.

14. The imaging system according to claim 1, wherein:
the first optical axis and the second optical axis are parallel to each other, and
there is a parallel offset between the first optical axis and the second optical axis.

15. The imaging system according to claim 2, wherein:
the first optical axis and the second optical axis are parallel to each other at the intermediate image, and
there is a parallel offset between the first optical axis and the second optical axis at the intermediate image.

16. The imaging system according to claim 2, wherein the imaging system forms exactly one intermediate image.

17. The imaging system according to claim 1, wherein:
the imaging system is a catadioptric system having at least one curved mirror providing optical power, and
all mirrors of the optical system are curved mirrors.

18. The imaging system according to claim 1, wherein the imaging system does not have a planar folding mirror.

19. The imaging system according to claim 2, wherein:
the first imaging subsystem is a catadioptric subsystem that includes a concave mirror defining the first optical axis for imaging the off-axis object field into the intermediate image positioned in the vicinity of the object field and laterally offset to the object field such that there is no overlap between the object field and the intermediate image;
the second imaging subsystem is a dioptric subsystem having the second optical axis parallel to and offset from the first optical axis for imaging the intermediate image onto the image surface;
the intermediate image is off-axis with respect to the first optical axis; and
the second imaging subsystem is arranged such that the intermediate image is essentially centered around the second optical axis.

20. The imaging system according to claim 19, wherein the first catadioptric subsystem provides an overcorrection of chromatic aberrations at a close to unity magnification such that the intermediate image has approximately the size of the object field and is overcorrected for the chromatic aberrations.
